(19) United States
(12) Patent Application Publication
(10) Pub. No.: US 2009/0216619 A1
(43) Pub. Date: Aug. 27, 2009

(54) METHOD FOR DETERMINING FAIR MARKET VALUES OF MULTIMEDIA ADVERTISING SPACES

(76) Inventor: Pierre TAVERNIER, Bondues (FR)

Correspondence Address: YOUNG & THOMPSON, 209 Madison Street, Suite 500, ALEXANDRIA, VA, 22314, US

(21) Appl. No.: 12/389,439

(22) Filed: Feb. 20, 2009

Related U.S. Application Data
(60) Provisional application No. 61/030,242, filed on Feb. 21, 2008.

(51) Int. Cl. G06Q 30/00; G06Q 10/00; G06Q 20/00

(52) U.S. Cl. 705/10; 705/26; 705/14

(57) ABSTRACT

A method for determining fair market values of multimedia advertising spaces during a second time period, these multimedia advertising spaces having been bought during a first time period anterior to the second one by advertisers, includes:
collecting and storing audience statistics, advertising revenues and selected target audience categories of each of the advertising spaces during the first time period,
distributing the advertising revenues of each of the advertising spaces among the audience categories and summing these revenues per advertising space per audience category for all advertising spaces in order to determine total revenues of all advertising spaces per audience category during the first time period,
determining a global price per audience category for any advertising space during the first time period,
determining theoretical revenues of each of the advertising spaces per audience category during the first time period,
determining average theoretical revenues of each of the advertising space for at least a set of audience categories groups during the first time period,
determining a fair market value of each of the advertising spaces during the second time period.

### BACKGROUND OF THE INVENTION

1. Field of the Invention

The present invention relates generally to advertising exchanges and more particularly, to a method for determining fair market values of multimedia advertising spaces during a given time period and to a computer system implementing this method. It also relates to a method of selling multimedia advertising spaces and an internet system to implement this method.

2. Description of the Related Art

Advertising exchanges are open marketplaces bringing advertisers and publishers together on a website, thus simplifying the execution of advertising space transactions. Advertising exchanges have been inspired by financial markets such as NYSE or NASDAQ and are therefore bringing the advertising industry the benefits of stock markets such as liquidity, transparency or cost-efficiency. They are an attempt to replicate financial exchange models on the advertising industry. Online advertising leaders have identified the potential of advertising exchanges and have heavily invested to acquire advertising exchange technologies and networks.

Presently these exchanges sell advertising spaces on a single auction (or demand auction) basis. Each advertising space is auctioned and the advertiser offering the highest bid wins. Publishers are selling their spaces to highest paying advertisers.

As advertising exchanges are implementing single auctions, potential over/under valuation is not addressed as the auction winner is always the highest bidder. Therefore all transactions are valued considering only buyers' expectations that could be overvalued or undervalued. Both parties never know if they are paying/receiving the fair market price considering global supply and demand. On one hand advertisers could obtain spaces at too expensive prices (especially in case of bidding wars). On the other hand publishers could trade high-value inventory at very cheap prices not knowing the true value of their inventory.

Due to this valuation issue, advertising exchanges are not very attractive for both publishers and advertisers. Therefore mostly remnant inventory is traded on advertising exchanges. The vast majority of premium spaces are sold through a traditional process at fixed prices which implies many intermediaries and therefore significant cost-inefficiencies.

### SUMMARY OF THE INVENTION

The present invention gives a methodology to ensure real-time fair market pricing of advertising transactions considering global supply and demand in order to overcome the over/under valuation issue of advertising exchanges implied by the single auction process.

The present invention provides a method for determining fair market values of multimedia advertising spaces during a second time period, these multimedia advertising spaces having been bought during a first time period anterior to the second one by advertisers, comprising the steps of:

a) collecting and storing, in a first database, audience statistics of each of said advertising spaces during said first time period, these audience statistics allowing to quantify the audience ratings of each of said advertising spaces according to a given number of audience categories, wherein said audience categories are grouped into audience categories groups, each of these audience categories groups describing the whole audience,

b) collecting and storing, in a second database, advertising revenues of each of said advertising spaces during said first time period,

c) said advertisers having specified a target audience by selecting target audience categories when buying each of said advertising spaces, collecting and storing, in a third database, selected target audience categories corresponding to the advertising revenues of each of said advertising spaces during said first time period,

d) based on data obtained in step a) and on data obtained in step b) and/or in step c), distributing said advertising revenues of each of said advertising spaces among said audience categories and summing these revenues per advertising space per audience category for all advertising spaces in order to determine the total revenues of all advertising spaces per audience category during said first time period,

e) based on data obtained in step a), determining a global audience rating of all advertising spaces per audience category during said first time period,

f) based on results of steps d) and e), determining a global price per audience category for any advertising space during said first time period by dividing said total revenues of all advertising spaces per audience category by said global audience rating of all advertising spaces per audience category,

g) based on the result obtained in step f) and on data obtained in step a), determining theoretical revenues for each of said advertising spaces per audience category during said first time period by multiplying said global price per audience category by a corresponding audience rating per advertising space per audience category during said first time period,

h) based on the result obtained at step g), determining average theoretical revenues for each of said advertising spaces for at least a set of audience categories groups during said first time period,

i) based on the result obtained at step h) and on the database obtained in step a), determining a fair market value of each of said advertising spaces during said second time period by dividing said average theoretical revenues of each of said advertising spaces by an audience rating of the corresponding advertising space during said first time period.

Thanks to this method, advertising spaces are priced at their fair market value at a given time period. This market value is adjusted continuously to reflect market supply and demand.

Advertisers are then able to select the advertising spaces they want to advertise on by taking into consideration their performance towards the specific audience target they want to reach, without being influenced by other subjective criteria, such as reputation.

Publishers are then also able to assess if their websites are performing better than the ones of their competitors and adjust their content accordingly.

This method allows the calculation on an on-going basis of indexes so that advertisers can assess if the advertising market is bullish or bearish and plan their investing decisions accordingly.

This fairer valuation could enable advertising exchanges to realize their full potential by concentrating in one place global multimedia advertising transactions, providing actors with market trends, media performance indicators and audience value indexes or issuing financial derivatives (options, futures) to help cover the implied risk of future transactions. All these benefits will help both advertisers and publishers to streamline the multimedia advertising industry.

According to the present method, said multimedia advertising spaces can be any kind of advertising spaces, including but not limited to online spaces of internet web pages, broadcast spaces on television, cinema or radio, outdoor spaces or spaces in printed media.

Said audience categories groups comprise at least one of the following: gender, age, income, education, language, hobbies, interests, searched keywords and web pages visited.

According to the present method, in step h), said average theoretical revenues of each of said advertising spaces for at least a set of audience categories groups is calculated by

summing said theoretical revenues of each of said advertising spaces per audience category for said set of audience categories of each group in order to obtain theoretical revenues of each of said advertising spaces per audience group during said second time period, and

averaging said theoretical revenues of each of said advertising spaces per audience group for said set of audience groups.

Alternatively, in step h), said average theoretical revenues of each of said advertising spaces for all audience is calculated by

summing said theoretical revenues of each of said advertising spaces per audience category for at least a set of audience categories of each group in order to obtain theoretical revenues of each of said advertising spaces per audience group during said first time period, and

multiplying said theoretical revenues of each of said advertising spaces per audience group by a weighting coefficient, the sum of the weighting coefficients for all audience groups considered being 1.

Said weighting coefficient is calculated for each audience categories group through the following steps:

distributing said advertising revenues of each of said advertising spaces only among target audience group specified by the advertiser and summing these revenues per advertising space per audience categories group for all advertising spaces in order to determine the total revenues of all advertising spaces per audience categories group during said first time period, and

summing said total revenues of all advertising spaces per audience group for all groups in order to determine total revenues of all advertising spaces, and

dividing said total revenues of all advertising spaces per audience group by said total revenues of all advertising spaces and multiplying by 100.

In step e), said global audience rating of all advertising spaces per audience category during said first time period is calculated by summing said audience of each of said advertising spaces per audience category collected in step a) for all advertising spaces.

In step i), said audience rating of each of the advertising spaces during said first time period is calculated by summing said audience of each of said advertising spaces per audience category collected in step a) for all categories of a given audience category group.

Said advertising spaces exhibiting different format, the present method comprises the following steps:

j) said advertisers having specified a target format by selecting a target format category when buying said advertising spaces, collecting and storing, in a fourth database, selected target format corresponding to the advertising revenues of each of said advertising spaces during said first time period,

k) distributing said advertising revenues generated by each of said advertising spaces among advertising space format in order to obtain total revenues per advertising space format,

l) calculating average revenues per advertising space per format by dividing said total revenues per advertising space format by the number of advertising spaces of the corresponding format,

m) calculating average revenues per advertising space by dividing total revenues of all advertising spaces by the total number of advertising spaces,

n) calculating a format correction coefficient for each advertising space format by dividing said average revenues per advertising space per format by said average revenues per advertising space,

p) calculating a corrected fair market value of each of said advertising spaces during said second time period by multiplying said fair market value determined in step h) by the corresponding format correction coefficient.

Any combination of two or more audience categories, each of them belonging to a distinct audience categories group, defines an audience sub-category.

According to the present method, total revenues of all advertising spaces per audience sub-category and global audience rating of all advertising spaces per audience sub-category are determined and a global price per audience sub-category is calculated by their ratio.

The present invention also provides a computer system for determining fair market values of multimedia advertising spaces during a second time period, these multimedia advertising spaces having been bought during a first time period anterior to the second one by advertisers, comprising:

tracking means for collecting each advertising spaces revenues and corresponding target audience, said advertisers having specified a target audience by selecting target audience categories when buying said advertising space,

first means for inputting and storing in a first database audience statistics of each of said advertising spaces during said first time period, these audience statistics allowing to quantify the audience of each of said advertising spaces according to a given number of audience categories, wherein said audience categories are grouped into audience categories groups, each of these audience categories groups describing the whole audience,

second means for inputting and storing advertising revenues generated by each of said advertising spaces during said first time period and corresponding selected target audience categories in a second and a third database,

computer processor means for processing data stored in said first and second and/or third database, programmed to: distribute said advertising revenues of each of said advertising spaces among said audience categories and summing these revenues per advertising space per audience category for all advertising spaces in order to determine the total revenues of all advertising spaces per audience category during said first time period; determine the global audience rating of all advertising spaces per audience category during said first time period; determine a global price per audience category for any advertising space during said first time period by dividing said total revenues of all advertising spaces per audience category by said global audience rating of all advertising spaces per audience category; determine theoretical revenues of each of said advertising spaces per audience category during said second time period by multiplying said global price per audience category by the audience of each of said advertising spaces for the corresponding category during said first time period; determine average theoretical revenues of each of said advertising spaces for at least a set of audience categories groups during said second time period; determine the fair market value of each of said advertising spaces during said second time period by multiplying said average theoretical revenues of each of said advertising spaces by an audience rating of the corresponding advertising space during said first time period.

This computer system for determining fair market values of multimedia further comprises:

tracking means for collecting each advertising space audience statistics.

This computer system for evaluating a fair market value of multimedia advertising spaces further comprises:

third means for inputting and storing, in a fourth database, selected target format specified by advertisers when buying said advertising spaces by selecting a target format category and corresponding to the advertising revenues of each of said advertising spaces during said first time period,

said computer processor means being programmed to process data stored in said fourth database, in order to: distribute said advertising revenues generated by each of said advertising spaces among advertising space format in order to obtain total revenues per advertising space format; calculate average revenues per advertising space per format by dividing said total revenues per advertising space format by the number of advertising spaces of the corresponding format; calculate average revenues per advertising space by dividing total revenues of all advertising spaces by the total number of advertising spaces; calculate a format correction coefficient for each advertising space format by dividing said average revenues per advertising space per format by said average revenues per advertising space; calculate a corrected fair market value of each of said advertising spaces during said second time period by multiplying said fair market value by the corresponding format correction coefficient.

The present invention also provides a method for selling multimedia advertising spaces, comprising the following steps:

receiving from an advertiser a request for an advertisement to be exposed to a target audience,

identifying a list of advertising spaces with highest target audience proportion,

calculating the fair market value of said identified advertising spaces according to said method for determining a fair market value of multimedia advertising spaces,

calculating a return on investment index, by dividing the target audience by the global audience of said advertising spaces to obtain a target audience percentage, and dividing this target audience percentage by the calculated fair market value of said advertising spaces,

selecting the advertising spaces of said list with highest return on investment index,

returning the fair market value of the selected advertising spaces to the advertiser

receiving advertiser's payment,

storing said advertisement in a fifth database.

automatically displaying said advertisement in said selected advertising spaces.

This method for selling multimedia advertising spaces further comprises steps j) to step p) of the method for determining a fair market price of multimedia advertising spaces described previously.

Alternatively, the method for selling multimedia advertising spaces according to the invention comprises the following steps:

receiving from an advertiser a request for an electronic advertisement to be exposed to a target audience,

identifying a list of advertising spaces with highest target audience proportion,

calculating the fair market value of said identified advertising spaces according to said method for determining a fair market value of multimedia advertising spaces,

returning said list of identified advertising spaces along with their corresponding fair market value to the advertiser,

receiving an advertising space selection by the advertiser from said list.

This method for selling multimedia advertising spaces further comprises steps j) to step p) of the method for determining a fair market price of multimedia advertising spaces described previously.

This method for selling multimedia advertising spaces further comprises the following steps:

calculating, for each advertising space of said list, a return on investment index, by dividing the target audience by the audience rating of said advertising space to obtain a target audience percentage, and dividing this target audience percentage by the calculated fair market value of said advertising space,

returning corresponding return on investment index with said list of identified advertising spaces to the advertiser.

This method for selling multimedia advertising spaces further comprises the following steps:

receiving advertiser's payment,

storing said advertisement in a fourth database,

automatically displaying said advertisement in said advertising spaces.

This method for selling multimedia advertising spaces further comprises the following steps:

receiving a price request for said advertising spaces selection from the advertiser,

transmitting said price request to publishers of said advertising spaces selection.

This method for selling multimedia advertising further comprises the following steps:

receiving said advertising spaces publishers' approval,

storing said advertisement in a fourth database,

automatically displaying said advertisement in said advertising spaces.

The present invention also provides an internet system for selling multimedia advertising spaces, comprising:

a database operable for maintaining audience statistics data, advertising spaces data such as format, topic and revenues, advertisers data such as target audience selected, advertisement data,

a web server operable to:

receive from an advertiser a request for an advertisement to be exposed to a target audience,

identify a list of advertising spaces with highest target audience proportion,

calculate the fair market value of said identified advertising spaces according to said method for determining a fair market value of multimedia advertising spaces,

calculate a return on investment index of each of said identified advertising spaces, by dividing the target audience by the audience rating of said identified advertising spaces to obtain a target audience percentage, and dividing this target audience percentage by the calculated fair market value of said identified advertising spaces,

select the advertising spaces of said list with highest return on investment index,

return the fair market value of the selected advertising space to the advertiser,

receive advertiser's payment,

store said advertisement in said database,

automatically display said advertisement in said selected advertising space,

Said web server of the present internet system for selling multimedia advertising spaces is operable to execute step j) to step p) of the present method for determining fair market values of multimedia advertising spaces.

The present invention also provides an internet system for selling multimedia advertising spaces, comprising:

a database operable for maintaining audience statistics data, advertising spaces data such as format, topic and revenues, advertisers data such as target audience selected, advertisement data,

a web server operable to:

receive from an advertiser a request for an electronic advertisement to be exposed to a target audience,

identify a list of advertising spaces with highest target audience proportion,

calculate the fair market value of said identified advertising spaces according to said method for determining a fair market value of multimedia advertising spaces,

return said list of identified advertising spaces along with their corresponding fair market values to the advertiser,

Said web server of this internet system for selling multimedia advertising spaces according to the invention further comprises:

an online interface allowing advertisers to send a request for an advertisement and selecting means allowing the advertisers to select the target audience of said advertisement by specifying a target audience sub-category,

a computerized system for determining fair market values of multimedia advertising spaces,

identifying means to identify a list of advertising spaces with highest target audience proportion,

displaying means allowing to display the returned list of the identified advertising spaces along with their fair market values,

selecting means allowing the advertiser to choose the advertising spaces he wishes to advertise on from said returned list.

Said web server of this internet system for selling multimedia advertising spaces is also operable to execute step j) to step p) of the present method for determining fair market values of multimedia advertising spaces.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 is a diagram showing an embodiment of the advertising spaces selling and pricing systems,

FIG. 2 is a flow chart of the method for determining a fair market value of advertising spaces according to a preferred embodiment of the invention,

FIG. 3 is a flow chart of further steps of the method for determining a fair market value of advertising spaces according to an alternative embodiment of the invention,

FIG. 4 is a flow chart of the method of selling advertising spaces according to a preferred embodiment of the invention.

### DETAILED DESCRIPTION OF THE PREFERRED EMBODIMENTS

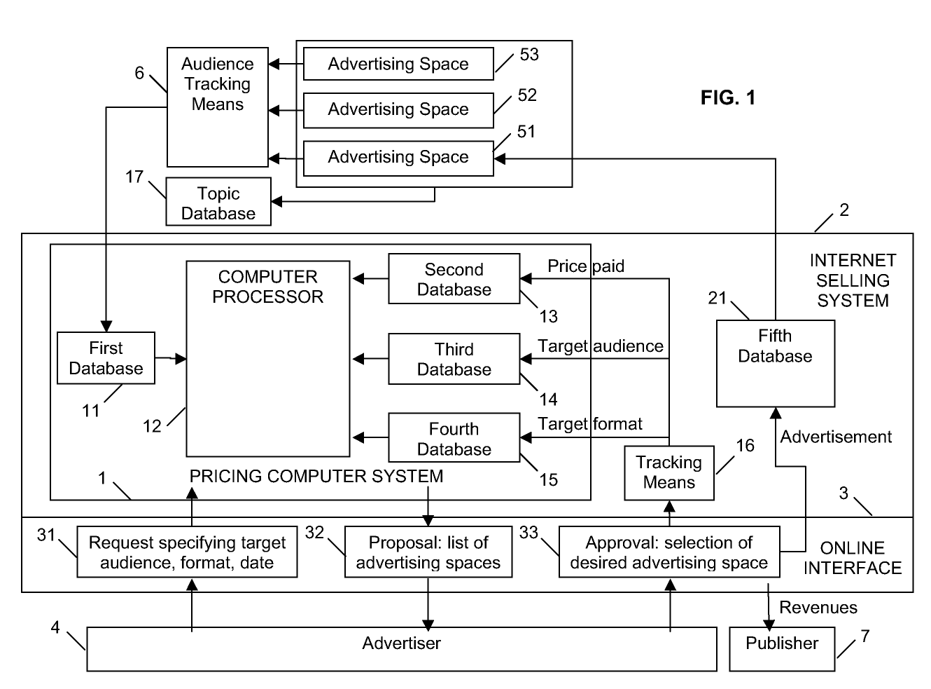

As represented on FIG. 1, the method for determining fair market values of multimedia advertising spaces according to the invention is applied by a pricing computer system 1 included in an advertising spaces internet selling system 2 to which several media publishers of different media outsource their advertising selling processes. It enables supply to meet demand on the advertising market. As a result the internet selling system processing advertising transactions is able to gather financial data (revenues of each advertising space, for example) and statistics of the market (for example, audience statistics).

In the present description, we will provide and explain detailed examples of how to apply a method for determining fair market values of advertising spaces and a method of selling advertising spaces for online display advertising, although it is clear that advertising spaces of any advertising medium such as, but not limited to, television, radio, printed media or outdoor advertising can also be priced using the method described here, as separated groups or as a whole, provided that sufficient audience statistics are available in order to characterize the population exposed to these advertising spaces.

As the following description applies to online display advertising, prices are expressed in Cost Per Thousand Impressions, hereafter referred as CPM, which refers to the cost of reaching one thousand advertising exposure opportunities. By exposure opportunity, we refer for example to the load of the specific web page on which is displayed the advertisement, regardless of the number of individual users loading said web page. Regarding television or radio advertising, the number of exposure opportunities could refer for example to an estimation of the number of viewers or listeners of a specific broadcasted advertisement. In printed media such as magazines, the number of exposure opportunities could relate to the number of said magazines sold. It can also be adapted to outdoor advertisement provided that sufficient data on individuals exposed to outdoor advertisements is available.

As it is clear that the method for determining fair market values of multimedia advertising spaces can be applied on other forms of advertising, it allows to express prices differently such as, but not limited to, CPC (Cost Per Click), CPA (Cost Per Acquisition/Action), CPV (Cost Per Visitor), CPE (Cost Per Engagement), eCPM (Effective CPM), eCPA (Effective CPA) or Cost Per Thousand GRP (Gross Rating Point).

As represented on FIG. 1, said internet selling system 2 according to the invention allows an advertiser 4 to connect onto an online interface 3. This advertiser 4 places an order for an advertising space by completing a request 31 and specifies a target audience for the advertisement to be exposed to.

Said internet selling system 2 identifies available advertising spaces with the highest proportion of target audience and the pricing computer system 1 evaluates fair market values for these advertising spaces. The internet selling system 2 calculates a return on investment index for each advertising spaces, which will be described in details later. The advertising spaces selling system returns to the advertiser a priced proposal 32 comprising a list of one or more advertising spaces (written down as “ad space” on FIG. 1) 51, 52, 53 according to their return on investment index, with their fair market values.

The advertiser 4 can then choose from this list, for example the advertising space 51, or choose another advertising space and approve the transaction by sending an approval signal 33 to the online interface 3. The advertisement to be displayed is transferred and stored in a fifth database 21 and the advertiser 4 pays online.

The corresponding advertising revenues for said advertising space 51 are recorded by the pricing system 1 and stored in a second database 13. Target audience data specified by the advertiser 4 in his request 31 and corresponding to said advertising revenues for the chosen advertising space are saved in a third database 14.

Said advertisement is displayed automatically on said advertising space 51 at the requested time specified in the request 31. Corresponding revenues are transferred online to associated publisher's 7 bank account.

Audience tracking means 6, for example an audience measurement company, track each advertising space 51, 52, 53 audience statistics. Audience statistics are uploaded onto the pricing computer system 1 and stored in a first database 11.

As represented on FIG. 1, the pricing system 1 comprises a computer processor 12 programmed to execute a pricing algorithm that confronts advertising spaces revenues' data stored in said second database 13 to the audience statistics data stored in said first database 11 to calculate a fair market value of each of the advertising spaces available. Other market indicators characterizing advertising spaces 51, 52, 53 prices are calculated as well.

The method for determining a fair market value according to the invention valuates advertising spaces on a period-to-period basis. Every time period, advertising spaces revenues and audience statistics are computed to determine the market value of each advertising space. During the following time period, an advertising space order is valued on the basis of this market value and so on for the following time periods.

The method for determining a fair market value described here is designed to valuate advertising spaces according to their audience characteristics. In order to achieve this goal, the value of a given audience has to be quantified.

Said given audience is therefore characterized by a given number of audience features (gender, age . . . ) that each defines an audience categories group. Each audience feature can indeed have at least two different values that define as many audience categories among which the whole audience can be divided up (for example, the gender categories group comprises two categories: male and female).

Audience can then be precisely characterized by a combination of one category of two or more categories groups, hereafter called audience sub-category.

Audience categories groups taken into account are of course defined in relation with the advertiser's criteria for targeting the most pertinent audience.

Common audience features of interest for advertisers include demographic data such as gender, age, education and income, as represented in table 1. This table shows an example of categories that can be comprised in these demographic categories groups.

TABLE 1

| Demographic categories groups | Demographic categories |
|---|---|
| Gender | Male |
| | Female |
| Age | 12-24 |
| | 25-34 |
| | 35-54 |
| Education | No College |
| | College |
| Income | $0-35k |
| | $35-65k |
| | $65-100k |

Advertisers can also be interested in contextual features of the audience referring to the features of the medium displaying the advertisement. A non exhaustive list of examples of contextual audience categories groups and contextual categories is displayed in table 2.

TABLE 2

| Contextual categories groups | Contextual categories |
|---|---|
| Language | English |
| | Spanish |
| Topic | News |
| | Sport |
| | Fashion |

For example, an advertiser can choose to display a TV-spot only on English-speaking channels specialized on sport. He can also specify to the system that he wants a flash-interactive banner advertisement to be loaded on Spanish-speaking web pages specialized on fashion. The contextual categories of each medium included in the network are specified upfront to the pricing computer system 1.

The audience can also be characterized based on behavioral criteria referring to the actions or reactions of people to whom the advertisement is to be displayed to. A non exhaustive list of examples of behavioral audience categories groups and behavioral categories is displayed in table 3.

TABLE 3

| Behavioral categories groups | Behavioral categories |
|---|---|
| Searched Keywords | Car |
| | Flower delivery |
| Web page visited | www.yahoo.com/technology |
| | www.FT.com |
| | www.youtube.com |

For example, an advertiser can choose to display a flash-interactive banner advertisement only to web users who previously searched for keyword “Laptop” on a search engine and who previously visited the web page www.technology.com.

The method for determining a fair market value described here can take into account a large number of audience categories groups and categories. This number is only limited by the computer processor power. It is also possible to upgrade this pricing method by adding new audience categories groups and categories whenever needed.

When an advertiser posts a request for an advertising space, he is given the possibility of defining a target audience to be exposed to his advertisement. This target audience is defined by selecting a target category for one or more categories groups. If the advertiser selects a target category for two or more groups, a target audience sub-category is selected.

Audience can also depend on the format of the advertising space chosen. For example, on the internet network, video advertisements are supposed to have more impact on potential customers than flash banners. The format of the advertisement is then also taken into account by the method for determining a fair market value described here.

The internet network comprises many websites. Each of these websites comprises several web pages, that each comprises different advertising spaces. The method for determining a fair market value of advertising spaces according to the invention is to determine the fair market value of each of these advertising spaces.

In the case of internet web pages, the audience rating of an advertising space is quantified by a number of impressions of the web page hosting it, that is to say by the number of times the web page comprising said advertising space is loaded by a user's browser. It does not take into account the number of individual users.

Audience statistics thus do not directly distinguish between advertising spaces of a same web page. However, advertising spaces of the same web page can be distinguished according to additional criteria such as format. The fair market value of advertising spaces of the same web page will thus be corrected according to these additional criteria.

The time period used by the method for determining a fair market value has to be specified upfront to the pricing computer system 1: it can be any time period such as an hour, a minute or a second. In the example below, the time period selected is one day (24 hours).

However, the same method can be implemented using data (audience statistics, advertising space revenues . . . ) determined by a moving average on a given number of periods.

In the following examples, fair market values of advertising spaces are computed on a daily basis, and audience statistics of web pages are therefore also computed on a daily basis.

Audience statistics are measured by an online audience measurement system. This audience measurement system is here integrated into the internet selling system 2. Alternatively, the audience measurement system can be run by an independent company.

We will describe here in details a simplified example of use of the method for determining a fair market value of advertising spaces in a group of websites comprising only three websites A, B and C. Each website consists of 2 web pages A1, A2, B1, B2 and C1, C2.

Only three demographic audience categories groups are considered here: gender, age and income. The gender categories group is divided into two categories: male and female. The age categories group is here divided into three categories: 18-24 years old; 25-54 years old; 55 years old and over. The income categories group is here divided into three categories: Low, Medium and High.

One contextual categories group regarding the topic of each web page is considered with two categories: Fashion and Sport.

However the method for determining a fair market value of advertising spaces could work with hundreds of targeting audience features.

In addition, only two advertising spaces format are considered (vertical flash banner and video square). Each web page has two advertising spaces: one supporting vertical flash banners and one supporting video squares. Of course the method for determining a fair market value of advertising spaces could work with a multitude of different advertising formats.

The first two steps of the method of evaluating a fair market value for advertising spaces deal with data collection.

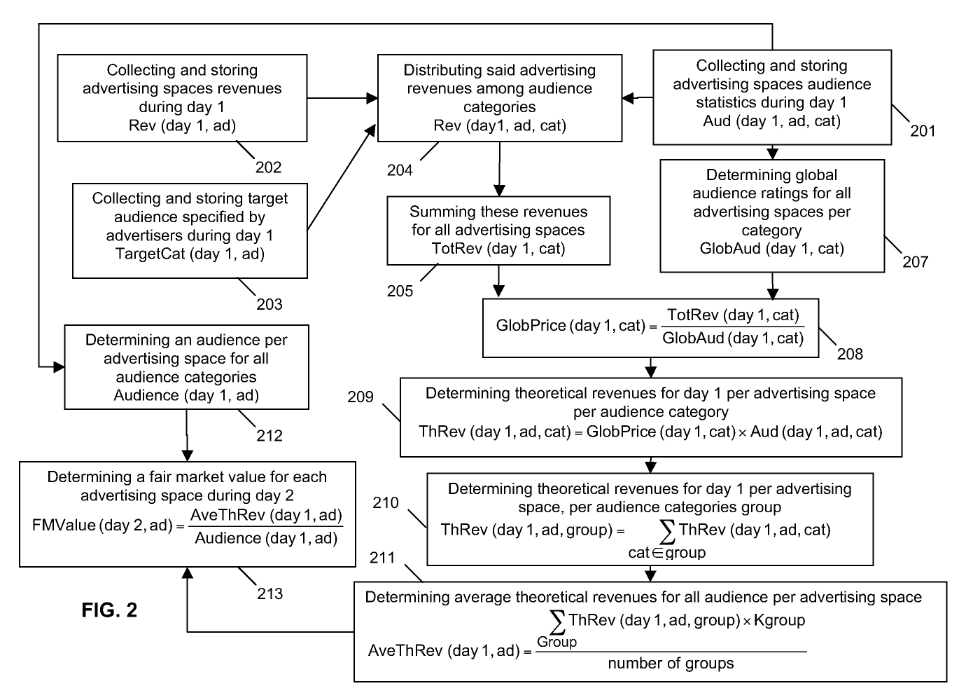

In step a) represented on FIG. 2 in block 201, audience statistics of each of said advertising spaces during a first time period hereafter named day 1 are collected and stored in the first database 11. These audience statistics give access to audience ratings during day 1, per advertising space (ad) per category (cat), written down as Aud(day 1, ad, cat) on FIG. 2.

Table 4 shows a typical report obtained from an online audience measurement system characterizing audience of web pages A, B and C during day 1. For simplification's sake, only demographic categories groups are taken into account in the following table. Audience ratings are expressed in thousand sold impressions.

TABLE 4

| | Audience ratings of | | Audience ratings of | | Audience ratings of | | |
|---|---|---|---|---|---|---|---|
| | Web site A | | Web site B | | Web site C | | |
| | Webpage | Webpage | Webpage | Webpage | Webpage | Webpage | Global |
| | A1 | A2 | B1 | B2 | C1 | C2 | audience |
| Demographic audience | Topic | | | | | | ratings per |
| sub-category | Fashion | Sport | Fashion | Sport | Fashion | Sport | sub-category |
| Male/18-24/Low | 445 | 765 | 925 | 385 | 440 | 405 | 3 365 |
| Male/18-24/Medium | 195 | 605 | 730 | 195 | 320 | 290 | 2 335 |
| Male/18-24/High | 30 | 350 | 465 | 35 | 255 | 90 | 1 225 |
| Male/25-54/Low | 470 | 835 | 1 105 | 455 | 475 | 425 | 3 765 |
| Male/25-54/Medium | 225 | 665 | 895 | 275 | 385 | 345 | 2 790 |
| Male/25-54/High | 60 | 395 | 570 | 65 | 265 | 130 | 1 485 |
| Male/55+/Low | 485 | 980 | 1 155 | 475 | 500 | 485 | 4 080 |
| Male/55+/Medium | 385 | 715 | 920 | 330 | 435 | 390 | 3 175 |
| Male/55+/High | 95 | 470 | 610 | 120 | 315 | 225 | 1 835 |
| Female/18-24/Low | 445 | 805 | 990 | 450 | 445 | 415 | 3 550 |
| Female/18-24/Medium | 220 | 615 | 805 | 255 | 335 | 325 | 2 555 |
| Female/18-24/High | 55 | 355 | 520 | 40 | 255 | 105 | 1 330 |
| Female/25-54/Low | 480 | 980 | 1 110 | 460 | 475 | 425 | 3 930 |
| Female/25-54/Medium | 250 | 700 | 905 | 280 | 400 | 385 | 2 920 |
| Female/25-54/High | 85 | 420 | 600 | 95 | 265 | 190 | 1 655 |
| Female/55+/Low | 490 | 985 | 1 160 | 530 | 680 | 730 | 4 575 |
| Female/55+/Medium | 435 | 765 | 920 | 380 | 440 | 400 | 3 340 |
| Female/55+/High | 150 | 595 | 615 | 175 | 315 | 240 | 2 090 |
| TOTAL | 5 000 | 12 000 | 15 000 | 5 000 | 7 000 | 6 000 | 50 000 |

In step b) represented in block 202, advertising revenues Rev(day 1, ad) generated by each of said advertising spaces during day 1 are collected and stored in the second database 13.

In step c) represented in block 203, the target audience category TargetCat(day 1, ad) or sub-category specified by the advertiser who selected a given advertising space is collected and stored in a third database 14 in correlation with the corresponding revenues of said given advertising space.

In step d) represented in block 204, said advertising revenues Rev(day1, ad) of each of said advertising spaces are distributed among said audience categories in order to obtain advertising revenues Rev(day1, ad, cat) per advertising space per audience category.

In order to achieve this step, said advertising revenues are first distributed among sub-categories that can be defined from the categories groups and categories specified to the pricing system 1.

In the preferred embodiment of the invention, this distribution is based on the target audience categories specified by the advertisers when buying each advertising space during day 1 and on the audience statistics of each advertising space during day 1.

A detailed example of this distribution is given below.

In a first transaction on day 1, an advertiser hereafter referred to as advertiser 1 has a video-square advertisement to display on the Internet. The product to advertise is a new skin-renewing treatment. As this product is expensive, advertiser 1 targets older women with high purchasing power visiting web pages specialized on Fashion. He selects the following target audience sub-category by selecting a category for each of the categories groups gender/age/income/topic: female/55+/high income/fashion.

At the end of the transaction, advertiser 1 buys an advertising space on web page B1 for 5 days (5 periods) for the price of $5,000 i.e. $1,000/day. His advertisement will be active on the beginning of day 2 and will be finished at the end of day 6.

These revenues are distributed according to the target audience sub-category chosen by advertiser 1 when he bought an advertising space on web page B1. The total amount paid is divided equally between the time periods during which the advertisement will be displayed.

For simplification's sake, demographic and contextual categories group are separated in the corresponding tables. The total amount paid is divided equally between the time periods during which the advertisement will be displayed.

Therefore, from day 2 to day 6, $1000 is allocated to the sub-category Female/55+/High, as shown in table 5a and $1000 per day is allocated to the fashion topic category, as shown in table 6a.

TABLE 5a

| | Total revenues of all advertising spaces | | | | | |
|---|---|---|---|---|---|---|
| | per demographic audience sub-category | | | | | |
| | Time period | | | | | |
| Demographic | Day | Day | Day | | | |
| audience sub-category | 1 | 2 | 3 | Day 4 | Day 5 | Day 6 |
| Male/18-24/Low | | | | | | |
| Male/18-24/Medium | | | | | | |
| Male/18-24/High | | | | | | |
| Male/25-54/Low | | | | | | |
| Male/25-54/Medium | | | | | | |
| Male/25-54/High | | | | | | |
| Male/55+/Low | | | | | | |
| Male/55+/Medium | | | | | | |
| Male/55+/High | | | | | | |
| Female/18-24/Low | | | | | | |
| Female/18-24/Medium | | | | | | |
| Female/18-24/High | | | | | | |
| Female/25-54/Low | | | | | | |
| Female/25-54/Medium | | | | | | |
| Female/25-54/High | | | | | | |
| Female/55+/Low | | | | | | |
| Female/55+/Medium | | | | | | |
| Female/55+/High | | 1 000 | 1 000 | 1 000 | 1 000 | 1 000 |
| TOTAL revenue/day | | 1 000 | 1 000 | 1 000 | 1 000 | 1 000 |

TABLE 6a

| | Total revenues of all advertising | | | | | |
|---|---|---|---|---|---|---|
| | spaces per contextual category | | | | | |
| Topic | Time period | | | | | |
| categories | Day 1 | Day 2 | Day 3 | Day 4 | Day 5 | Day 6 |
| Fashion | — | 1 000 | 1 000 | 1 000 | 1 000 | 1 000 |
| Sport | — | | | | | |
| TOTAL | — | 1 000 | 1 000 | 1 000 | 1 000 | 1 000 |
| revenue/day | | | | | | |

In more detailed charts, all sub-categories taking into account all combination of demographic and contextual categories could be drawn.

In a second transaction on day 1, an advertiser hereafter referred to as advertiser 2 has a vertical banner advertisement to display on the internet network. Advertiser 2 is willing to impact females aged between 18 and 24 years old without any constraint regarding their income level or the context of the web page the advertisement is to be displayed on. He selects the following target audience by selecting a category for two of the four categories groups, gender and age: he selects the target audience female/18-24 years old.

At the end of the transaction, advertiser 2 decides to advertise on web page A1 on which he buys a vertical banner advertising zone for 5 days starting on day 2. The cost of the order is $1,000/day.

Here, the audience target specified by advertiser 2 does not take into account the income or the topic of the webpage.

These revenues are thus distributed among all the target audience sub-categories that are comprised in the target audience specified by advertiser 2 according to the audience statistics for web page A1 on the day of the order. The figures displayed in table 7 are analyzed from the audience statistics that are expressed in thousand sold impressions:

TABLE 7
Audience statistics of Webpage A1 during day 1

| Demographic sub- | Number of thousand | Percentage of female/18-24 |
|---|---|---|
| category | impressions | audience |
| Female/18-24/Low | 445 | 62% |
| Female/18-24/Medium | 220 | 31% |
| Female/18-24/High | 55 | 7% |
| TOTAL | 720 | 100% |

Consequently, the revenues of that order is distributed among demographic audience sub-categories according to the webpage A1 audience characteristics regarding the income of females aged between 18 and 24 years old on day 1:

62% of $1,000 per day equals $620 per day is allocated to the demographic audience sub-categories female/18-24/Low.

31% of $1,000 per day equals $310 per day is allocated to the demographic audience sub-categories female/18-24/Medium.

7% of $1,000 per day equals $70 per day is allocated to the demographic audience sub-categories female/18-24/High.

If the target topic of the web page is not specified by the advertiser, as it is the case in this second example, the revenues are allocated to the topic of the chosen web page as memorized in the pricing system 1 in a sixth database 17.

These revenues are to be added to the revenues of web page B1 in table 5. The updated tables 5b and 6b are displayed below.

TABLE 5b

| | Total revenues of all advertising | | | | | |
|---|---|---|---|---|---|---|
| | spaces per demographic audience sub-category | | | | | |
| Demographic | Time period | | | | | |
| audience sub- | Day | Day | Day | | | |
| category | 1 | 2 | 3 | Day 4 | Day 5 | Day 6 |
| Male/18-24/Low | | | | | | |
| Male/18-24/Medium | | | | | | |
| Male/18-24/High | | | | | | |
| Male/25-54/Low | | | | | | |
| Male/25-54/Medium | | | | | | |
| Male/25-54/High | | | | | | |
| Male/55+/Low | | | | | | |
| Male/55+/Medium | | | | | | |
| Male/55+/High | | | | | | |
| Female/18-24/Low | | 620 | 620 | 620 | 620 | 620 |
| Female/18-24/Medium | | 310 | 310 | 310 | 310 | 310 |
| Female/18-24/High | | 70 | 70 | 70 | 70 | 70 |
| Female/25-54/Low | | | | | | |
| Female/25-54/Medium | | | | | | |
| Female/25-54/High | | | | | | |
| Female/55+/Low | | | | | | |
| Female/55+/Medium | | | | | | |
| Female/55+/High | | 1 000 | 1 000 | 1 000 | 1 000 | 1 000 |
| TOTAL revenue/day | | 2 000 | 2 000 | 2 000 | 2 000 | 2 000 |

TABLE 6b

| | Total revenues of all advertising spaces | | | | | |
|---|---|---|---|---|---|---|
| | per advertising space contextual category | | | | | |
| | Time period | | | | | |
| Topic | Day 1 | Day 2 | Day 3 | Day 4 | Day 5 | Day 6 |
| Fashion | — | 2 000 | 2 000 | 2 000 | 2 000 | 2 000 |
| Sport | — | | | | | |
| TOTAL | — | 2 000 | 2 000 | 2 000 | 2 000 | 2 000 |
| revenue/day | | | | | | |

The revenues per advertising space are thus distributed among audience sub-categories. This allows calculating the revenues for all advertising spaces per audience sub-category by summing the revenues per advertising space per audience sub-categories category for all advertising spaces (as represented in block 205). Total revenues TotRev(day 1 cat) of all advertising spaces per audience category are then obtained by summing the revenues for all advertising spaces per audience sub-category for all sub-categories comprised in one category.

For example, after all transactions have been completed on day 1, the total revenues of all advertising spaces per audience sub-category are displayed in table 8. Revenues are displayed in dollars.

TABLE 8

| | Total revenues of all |
|---|---|
| Demographic audience sub- | advertising spaces per |
| category | audience sub-category |
| Male/18-24/Low | 14 000 |
| Male/18-24/Medium | 66 000 |
| Male/18-24/High | 55 000 |
| Male/25-54/Low | 42 000 |
| Male/25-54/Medium | 87 000 |
| Male/25-54/High | 55 000 |
| Male/55+/Low | 30 000 |
| Male/55+/Medium | 94 000 |
| Male/55+/High | 64 000 |
| Female/18-24/Low | 9 000 |
| Female/18-24/Medium | 66 000 |
| Female/18-24/High | 52 000 |
| Female/25-54/Low | 41 000 |
| Female/25-54/Medium | 85 000 |
| Female/25-54/High | 60 000 |
| Female/55+/Low | 24 000 |
| Female/55+/Medium | 93 000 |
| Female/55+/High | 63 000 |
| TOTAL revenue/day | 1 000 000 |
| Fashion | 450 000 |
| Sport | 550 000 |
| TOTAL revenue/day | 1 000 000 |

The total revenues of all advertising spaces for the audience category age between 18 and 24 years old is for example obtained by summing the revenues of the following sub-categories:

Male/18-24/Low

Male/18-24/Medium

Male/18-24/High

Female/18-24/Low

Female/18-24/Medium

Female/18-24/High

Total revenues of all advertising spaces equal the total revenues of all advertising spaces per audience categories group, for any group. It is obtained in a similar fashion, by summing the revenues for all advertising spaces per audience category for all categories comprised in one group.

The total revenues of all advertising spaces per audience category and per categories group calculated from the data of table 8 are presented in table 9.

TABLE 9

| | Total revenues of all |
|---|---|
| | advertising spaces per |
| Audience categories and | audience category and per |
| groups | audience categories group |
| Male | 507 000 |
| Female | 493 000 |
| TOTAL Gender | 1 000 000 |
| 18-24 | 262 000 |
| 25-54 | 370 000 |
| 55+ | 368 000 |
| TOTAL Age | 1 000 000 |
| Low | 160 000 |
| Medium | 491 000 |
| High | 349 000 |
| TOTAL Income | 1 000 000 |
| Fashion | 450 000 |
| Sport | 550 000 |
| TOTAL Topic | 1 000 000 |

In step e), represented in block 207 of the method for determining fair market values of advertising spaces described here, a global audience rating GlobAud(day 1, cat) of all advertising spaces per audience category during said first time period is determined based on audience statistics collected in step a).

This global audience rating of all advertising spaces per audience category equals the total number of sold impressions per web page per audience category. An example of audience statistics is given in table 10 for the three web sites A, B and C considered here. Sold impressions are expressed in thousands.

One can note that numbers of sold impressions per audience sub-category can also be obtained from the audience statistics measured, giving access to audience ratings per audience sub-category.

TABLE 10

| | Audience ratings of Web | | Audience ratings of Web | | Audience ratings of Web | | |
|---|---|---|---|---|---|---|---|
| | site A | | site B | | site C | | Global |
| | Webpage A1 | Webpage A2 | Webpage B1 | Webpage B2 | Webpage C1 | Webpage C2 | audience |
| Audience | Topic | | | | | | ratings per sub- |
| category | Fashion | Sport | Fashion | Sport | Fashion | Sport | category |
| Male | 2 390 | 5 780 | 7 375 | 2 335 | 3 390 | 2 785 | 24 055 |
| Female | 2 610 | 6 220 | 7 625 | 2 665 | 3 610 | 3 215 | 25 945 |
| TOTAL Gender | 5 000 | 12 000 | 15 000 | 5 000 | 7 000 | 6 000 | 50 000 |
| 18-24 | 1 390 | 3 495 | 4 435 | 1 360 | 2 050 | 1 630 | 14 360 |
| 25-54 | 1 570 | 3 995 | 5 185 | 1 630 | 2 265 | 1 900 | 16 545 |
| 55+ | 2 040 | 4 510 | 5 380 | 2 010 | 2 685 | 2 470 | 19 095 |
| TOTAL Age | 5 000 | 12 000 | 15 000 | 5 000 | 7 000 | 6 000 | 50 000 |
| Low | 2 815 | 5 350 | 6 445 | 2 755 | 3 015 | 2 885 | 23 265 |
| Medium | 1 710 | 4 065 | 5 175 | 1 715 | 2 315 | 2 135 | 17 115 |
| High | 475 | 2 585 | 3 380 | 530 | 1 670 | 980 | 9 620 |
| TOTAL Income | 5 000 | 12 000 | 15 000 | 5 000 | 7 000 | 6 000 | 50 000 |
| Fashion | 5 000 | — | 15 000 | — | 7 000 | — | 27 000 |
| Sport | — | 12 000 | — | 5 000 | — | 6 000 | 23 000 |
| TOTAL Topic | 5 000 | 12 000 | 15 000 | 5 000 | 7 000 | 6 000 | 50 000 |

In the following step f), represented in block 208, a global price per audience category GlobPrice(day1, cat) for any advertising space during said first time period, hereafter named category CPM or “category cost per 1,000 impressions” is then calculated by dividing said total revenues TotRev(day 1, cat) of all advertising spaces per audience category by said global audience ratings GlobAud(day 1, cat) of all advertising spaces per audience category, as shown in table 11.

TABLE 11

| | | Global audience | |
|---|---|---|---|
| Audience | Total revenues of all | ratings per | |
| category | advertising spaces per | audience | |
| and | audience category | category and per | Category |
| category | audience category and per | audience | CPM of |
| group | audience categories group | categories group | day 1 |
| Male | 507 000 | 24 055 | 21 |
| Female | 493 000 | 25 945 | 19 |
| TOTAL | 1 000 000 | 50 000 | 20 |
| Gender | | | |
| 18-24 | 262 000 | 14 360 | 18 |
| 25-54 | 370 000 | 16 545 | 22 |
| 55+ | 368 000 | 19 095 | 19 |
| TOTAL Age | 1 000 000 | 50 000 | 20 |
| Low | 160 000 | 23 265 | 7 |
| Medium | 491 000 | 17 115 | 29 |
| High | 349 000 | 9 620 | 36 |
| TOTAL | 1 000 000 | 50 000 | 20 |
| Income | | | |
| Fashion | 450 000 | 27 000 | 17 |
| Sport | 550 000 | 23 000 | 24 |
| TOTAL | 1 000 000 | 50 000 | 20 |
| Topic | | | |

A global CPM for all advertising spaces and all audience can be calculated by dividing the total revenues of all advertising spaces by the global audience ratings. The total revenues of all advertising spaces equal the total revenues of all advertising spaces per any categories group and the global audience ratings equal the audience ratings of all advertising spaces per any categories group.

These category CPMs represent the market price of each category on day 1. For instance, on day 1 sold impressions initiated by males were fewer than those initiated by females. However advertisers spent more money on men than on women. Consequently the male category CPM is higher than the female category CPM because the demand to advertise on male is higher for a lower offer.

Similarly, people with high incomes represent a small share of the population. Nonetheless advertisers tend to concentrate on that category because of its high purchasing power. Thus they spend relatively more money to advertise on that category. Finally the demand of advertising on “high income” category is high but the offer of impressions initiated by people belonging to that category is low. As a result the high income category CPM is high. In the example displayed in table 11, the high income category CPM is $36 which means that, on day 1, advertisers were willing to pay $36 to have their advertisements displayed on 1,000 impressions initiated by people with “high income”.

Obviously those CPMs will fluctuate every period based on offer and demand of impressions. Thus they will give advertisers and publishers an indication on the cost of advertising to a specific audience category, in other words the trends of the market.

One can note that sub-category CPMs can be calculated in a similar fashion, provided that audience statistics allow to calculate a global audience ratings per audience sub-category. Sub-category CPMs are useful for advertisers who want to know the actual price and market trend of a specific audience target.

In step g) of the method for determining a fair market value of advertising spaces represented in block 209, theoretical revenues ThRev(day 1, ad, cat) of each of said advertising spaces per audience category during said first time period, corresponding here to day 1, are determined by multiplying said category CPM GlobPrice(day1, cat) by the audience Aud(day 1, ad, cat) of each of said advertising spaces for the corresponding category during day 1.

An example of this calculation is given in table 12, in the case of the web page A1.

TABLE 12

| | | | Theoretical |
|---|---|---|---|
| Audience | Audience statistics of | | revenues of |
| category | Webpage A1 in | Category | Webpage A1 on |
| and | thousands of | CPM | day 1 per |
| category group | impressions on day 1 | on day 1 | category |
| Male | 2 390 | 21 | 50 373 |
| Female | 2 610 | 19 | 49 595 |
| TOTAL Gender | 5 000 | — | 99 968 |
| 18-24 | 1 390 | 18 | 25 361 |
| 25-54 | 1 570 | 22 | 35 110 |
| 55+ | 2 040 | 19 | 39 315 |
| TOTAL Age | 5 000 | — | 99 786 |
| Low | 2 815 | 7 | 19 360 |
| Medium | 1 710 | 29 | 49 057 |
| High | 475 | 36 | 17 232 |
| TOTAL Income | 5 000 | — | 85 649 |
| Fashion | 5 000 | 17 | 83 333 |
| Sport | — | 24 | — |
| TOTAL Topic | 5 000 | — | 83 333 |

Then, in a step h), average theoretical revenues of each of said advertising spaces for all audience categories groups during day 1 are determined.

Theoretical revenues ThRev(day 1, ad, cat) of each advertising space per categories group can be calculated by summing theoretical revenues of each advertising space per audience category for all audience categories of a categories group, as shown in table 12 in the case of web page A1 on the lines labeled TOTAL “Group”. This step is schematically represented on FIG. 2 in block 210.

Average theoretical revenues AveThRev(day 1, ad) of each of said advertising spaces for all audience categories groups during day 1 are determined by averaging said theoretical revenues of each advertising space per categories group for all categories groups (block 211 of FIG. 2).

According to the preferred embodiment of the invention, said theoretical revenues of each advertising space per categories group are weighted by a weighting coefficient written down as Kgroup on FIG. 2. This weighting coefficient quantifies the interest of the advertisers for each of the categories groups.

A weighting coefficient is thus calculated for each audience categories group. In order to calculate this weighting coefficient, the total revenues of all advertising spaces per audience categories group during day 1 are determined by distributing said advertising revenues of each of said advertising spaces only among the target audience categories group specified by the advertiser and summing these revenues per advertising space per target audience categories group for all advertising spaces.

For example, advertiser 1 specified the following target audience sub-category: Female/55+/High Income/Fashion. The revenues generated by this first transaction were $1,000/day from day 2 to day 6. Advertiser 1 thus targets a specific audience category of each of the four available audience categories groups. One can then consider that each of the audience categories group is of the same importance to advertiser 1. Consequently, the revenues generated by this first transaction are distributed evenly among the four categories groups.

Advertiser 2 specified the following target audience: Female/18-24. The revenue generated by this second transaction was $1,000/day from day 2 to day 6. Advertiser 2 thus targets a specific audience category of only Gender and Age categories groups. One can then consider that Income and Topic categories groups did not have any importance to advertiser 2. Consequently, the revenues generated by this second transaction are distributed evenly among the two categories groups specified: Gender and Age.

A third advertiser, hereafter referred to as advertiser 3, specified the following target audience: Male. The revenues generated by this third transaction were $1,000/day from day 2 to day 6. One can then consider that Age, Income and Topic categories groups did not have any importance to advertiser 3. Consequently, the revenues generated by this third transaction are distributed to the only categories group specified: Gender.Table 13 summarizes the distribution of the revenues among categories groups for the three previous examples.

TABLE 13

| | | | | | | | | Total | |
|---|---|---|---|---|---|---|---|---|---|
| | | | | | | | | revenues of | Weighting |
| | | | | | | | | all advertising | coefficient |
| | | | | | | | | spaces per | of each |
| Audience | | | | | | | | audience | audience |
| categories | | | | | | | | categories | categories |
| group | Advertiser | Day 1 | Day 2 | Day 3 | Day 4 | Day 5 | Day 6 | group | group |
| Gender | Advertiser 1 | — | 250 | 250 | 250 | 250 | 250 | 8 750 | 58.33% |
| | Advertiser 2 | — | 500 | 500 | 500 | 500 | 500 | | |
| | Advertiser 3 | — | 1 000 | 1 000 | 1 000 | 1 000 | 1 000 | | |
| Age | Advertiser 1 | — | 250 | 250 | 250 | 250 | 250 | 3 750 | 25.00% |
| | Advertiser 2 | — | 500 | 500 | 500 | 500 | 500 | | |
| | Advertiser 3 | — | — | — | | | | | |
| Income | Advertiser 1 | — | 250 | 250 | 250 | 250 | 250 | 1 250 | 8.33% |
| | Advertiser 2 | — | — | — | — | — | — | | |
| | Advertiser 3 | — | — | — | — | — | — | | |
| Topic | Advertiser 1 | — | 250 | 250 | 250 | 250 | 250 | 1 250 | 8.33% |
| | Advertiser 2 | — | — | — | — | — | — | | |
| | Advertiser 3 | — | — | — | — | — | — | | |

| | | | | | | | | |
|---|---|---|---|---|---|---|---|---|
| TOTAL | — | 3 000 | 3 000 | 3 000 | 3 000 | 3 000 | 15 000 | 100% |

The weighting coefficient of each categories group is calculated as the percentage of total revenues of all advertising spaces per target audience categories group among the total revenues of all advertising spaces, the total revenues of all advertising spaces being equal to the sum over all categories groups of the total revenues of all advertising spaces per target audience categories group.

For example, in table 13, the weighting coefficient of the gender categories group equals 8750/15000*100=58.33%.

Average theoretical revenues of each of said advertising space for all audience categories groups during day 2 is then calculated by multiplying the theoretical revenues of each advertising space per categories group for all categories groups by this coefficient and summing the weighted theoretical revenues of each advertising space per categories group thus obtained for all groups.

In the case of web page A1, the average theoretical revenues is calculated as 58.33%*99 968+25%*99 786+8.33%*85 649+8.33%*83 333=$97 336.

According to an alternative embodiment of the invention, the weighting coefficient for each audience categories group can be optionally specified by advertisers during the purchase order process to ensure the determination of an even more precise weighting coefficient.

According to another alternative embodiment of the invention, the average theoretical revenues of each of said advertising spaces for all audience categories groups during day 2 can be calculated as a simple average of the theoretical revenues of each advertising space per categories group for all categories groups.

In that case, for web page A1, the average theoretical revenues are then calculated as (99,968+99,786+85,649+83,333)/4=$92,184.

Finally, in step i) represented in block 213, the fair market value FMValue(day 2, ad) of each of said advertising spaces during said second time period is determined by dividing said average theoretical revenues AveThRev(day 1, ad) of each of said advertising spaces by an audience rating Audience (day 1, ad) of the corresponding advertising space during day 1.

In the case of web page A1, its audience rating as displayed in table 12 is 5000 thousands sold impressions on day 1. The audience rating Audience(day1, ad) of each webpage equals the sum of its number of impressions per audience category for all audience categories of a categories group. It is calculated from the audience statistics (block 212). The fair market value of the advertising spaces of web page A1 is then calculated by dividing its average theoretical revenues by its audience rating in thousands impressions: $97 336/5 000=$19.46. The fair market value of web page A1 is $19.46.

A website fair market value can be determined as the weighted average of its web pages fair market value, for example by summing each web page fair market value multiplied by its audience rating and dividing this sum by the sum of the audience rating of each web page, for all web pages of a single web site.

In the case of web site A, the calculated fair market value of web page A1 is 19.46. The calculated fair market value of web page A2 is 20.71. Web page A1 audience rating on day 1 is 5 000 thousands sold impressions, and Web page A2 audience rating on day 1 is 12 000 thousands sold impressions, as shown in table 12. Web site A fair market value then equals to: (5000*$19.46+12 000*$20.71)/(5 000+12 000)=$20.09.

A global fair market value or global CPM is also calculated as follows:

Global fair market value on day 1=Overall Revenues on day 1/Overall Impressions on day 1.

Overall revenues designate all revenues on day 1 and overall impressions the total number of sold impressions on day 1, for all advertising spaces.

In the examples detailed earlier the global fair market value thus equals $1 000 000/50 000=$20.00.

The global fair market value is a market indicator. It enables market actors, such as advertisers and publishers to identify market trends. Basically a web page having a higher fair market value than the global fair market value has a more qualitative audience than average.

According to the preferred embodiment of the present invention, in order to consider different formats of online advertising spaces, markets should be segregated by formats i.e. one market implementing the method for determining fair market values of multimedia advertising spaces should be created for each format. In addition, to consider the performance of each advertising space, a performance category is taken into account in the present method. For instance a CTR (click-through rate—see detailed description below) category with 2 sub-categories (above and below 10%) is taken into account.

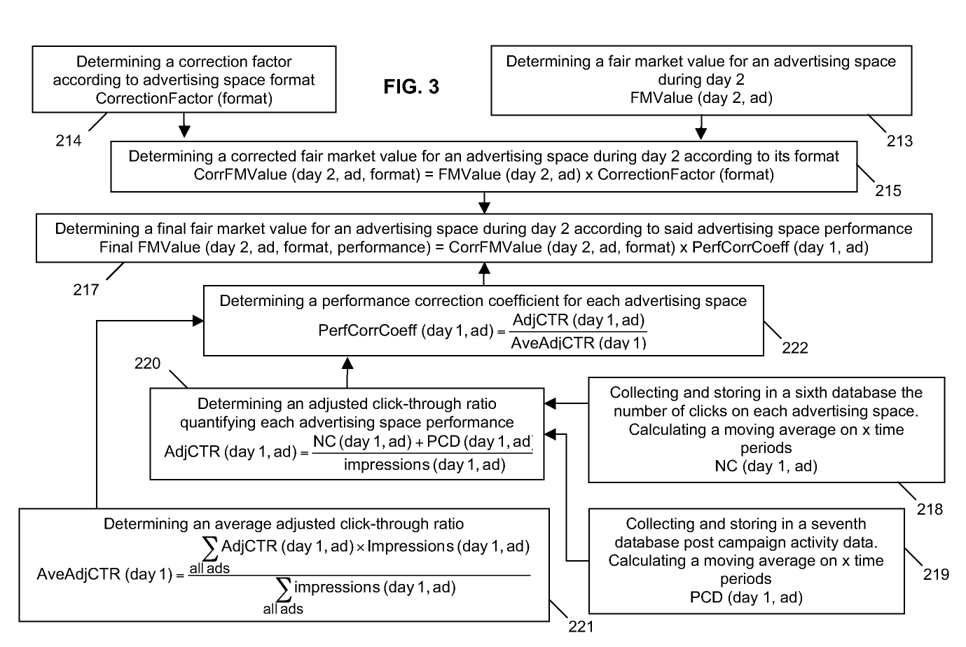

In an alternative embodiment of the present invention, online advertising spaces of different formats are available on the same market. The fair market value can then be corrected according to the format and to the performance of each advertising space as represented on FIG. 3.

In order to take the format of each advertising space into account, the format of the advertising spaces requested by advertisers is tracked and revenues of the advertising spaces are distributed among these formats.

In the case of the two transactions described earlier initiated by advertiser 1 and advertiser 2, the following table 14 shows the revenues distribution between the two possible formats considered.

TABLE 14

| | Total revenues of all advertising spaces | | | | | |
|---|---|---|---|---|---|---|
| | per advertising space format | | | | | |
| | Time period | | | | | |
| Format | Day 1 | Day 2 | Day 3 | Day 4 | Day 5 | Day 6 |
| Video Square | — | 1 000 | 1 000 | 1 000 | 1 000 | 1 000 |
| Vertical Banner | — | 1 000 | 1 000 | 1 000 | 1 000 | 1 000 |
| TOTAL | — | 2 000 | 2 000 | 2 000 | 2 000 | 2 000 |
| revenue/day | | | | | | |

After all transactions have been completed on day 1, an example of the total revenues of all advertising spaces per format is displayed in the first column of table 15. Revenues are displayed in dollars.

TABLE 15

| | | | Average | |
|---|---|---|---|---|
| | | | revenues | |
| | | Number of | per advertising | Revenue |
| | Revenue per | advertising | space per | ratio to |
| | format | spaces | format | average |
| Video Square | 600 000 | 6 | 100 000 | 1.20 |
| Vertical Banner | 400 000 | 6 | 66 667 | 0.80 |
| All advertising | 1 000 000 | 12 | 83 333 | 1.00 |
| spaces | | | | |

Average revenues per advertising space per format is then calculated by dividing said total revenues per advertising space format by the number of advertising spaces of the corresponding format.

In the example considered here, websites A, B and C each exhibits two web pages comprising an advertising space of each format.

The number of video-square advertising spaces and vertical banner advertising spaces each equals to 6, as shown in table 15.

Average revenues per advertising space are calculated here by dividing total revenues of all advertising spaces by the total number of advertising spaces. In the example, average revenues per advertising space is $83 333.

A format correction coefficient CorrectionFactor(format) for each advertising space format is then calculated by dividing said average revenues per advertising space per format by said average revenues per advertising space (block 214).

In the example displayed in table 15, the video-square format correction coefficient equals 1.20.

A format correction coefficient over 1 means that advertisers are willing to pay more for said format. Here, advertisers consider that the video square format is more effective than the vertical banner format.

A corrected fair market value CorrFMValue(day 2, ad, format) of each of said advertising spaces during day 2 is calculated by multiplying said fair market value determined in step i) by the corresponding format correction coefficient, as represented in block 215 of FIG. 3.

For example, in the case of a video-square advertising space on web page A1 whose fair market value as calculated previously is $19.46, the corrected fair market value will be $19.46*1.20=$23.35.

The fair market value calculated in step i), or the corrected fair market value determined by multiplying said fair market value determined in step i) by the corresponding format correction coefficient can also be corrected according to the performance of each advertising space.

Advertising spaces may exhibit different levels of performance regardless of their formats. For example, an advertising space placed at the bottom of a long web page will have a lower impact on viewers than advertising spaces placed at the top of the web page.

The performance of an online advertising space can be taken into account in order to further correct said corrected fair market value through the following steps.

As represented in block 218 of FIG. 3, the number of clicks on each advertising space is collected and stored in a sixth database. A click-through ratio is obtained for each advertising space by dividing the number of users who clicked on an advertisement on a web page by the number of impressions of this web page. For example, if an advertising banner was loaded 100 times, corresponding to 100 impressions and one click on this banner was recorded, the corresponding click-through ratio for this advertising banner is 1 percent.

An adjusted click-through ratio is determined by taking into account post campaign activity data of individuals exposed to an advertising space collected and stored into a seventh database (block 219). For example, an individual exposed to an advertisement on a given advertising space who does not click on this advertising space but subsequently visits the website advertised is taken into account by the adjusted click-through ratio. Indeed, if a user visits webpage A1 and views an advertisement for product X, a user's unique code is recorded. When the user visits the website related to product X later, this code is recognized, and post campaign activity data are recorded to calculate the adjusted click-through ratio. Post campaign activity data thus correspond to the numbers of visits of the website related to the advertisement displayed in this advertising space by viewers of this advertising space. An average number of clicks NC (day1, ad) and average post-campaign activity data PCD(day 1, ad) are determined for each advertising space on day 1 by a moving average of said number of clicks and said post campaign activity data over a given number of time periods.

The adjusted click-through ratio AdjCTR(day 1, ad) of a given advertising space is calculated (block 220) by summing the number of clicks on this advertising space and its post-campaign activity data, and dividing this sum by the number of impressions of the webpage comprising this advertising space.

This number of impressions of the webpage comprising said advertising space is also calculated by a moving average on said given number of time period.

An average adjusted click-through ratio AveAdjCTR(day 1, ad) is then calculated (block 221) by summing the adjusted click-through ratio of each advertising space multiplied by the corresponding number of impressions of each advertising space and dividing this sum by the sum of the number of impressions of all advertising spaces considered.

A performance correction coefficient PerfCorrCoeff(day 1, ad) is finally determined for each advertising space by dividing the adjusted click-through ratio of each advertising space by said average adjusted click-through ratio as represented in block 222 of FIG. 3.

As shown in block 217 of FIG. 3, the corrected fair market value calculated for a given advertising space format on a given web page can be further corrected in order to obtain a final advertising space fair market value FinalFMValue(day 2, ad, format, performance) by multiplying said corrected fair market value by said performance correction coefficient.

The present invention also regards a computer system 1 for determining fair market values of multimedia advertising spaces. This system is used to implement the method for determining a fair market value as was described earlier. As represented on FIG. 1, this computer system comprises:

tracking means 16 collecting each advertising space revenues and corresponding target audience, said advertisers having specified a target audience by selecting target audience categories when buying said advertising spaces,

first means for inputting and storing in said first database 11 audience statistics of each of said advertising spaces during day 1, these audience statistics allowing to quantify the audience of each of said advertising spaces according to a given number of audience categories, wherein said audience categories are grouped into audience categories groups, each of these audience categories groups describing the whole audience,

second means for inputting and storing advertising revenues generated by each of said advertising spaces during day 1 and corresponding selected target audience categories in said second 13 and third 14 databases,

said computer processor 12 means for processing data stored in said first 11 and second 13 and/or third 14 databases, programmed to: distribute said advertising revenues of each of said advertising spaces among said audience categories and summing these revenues per advertising space per audience category for all advertising spaces in order to determine the total revenues of all advertising spaces per audience category during day 1; determine the global audience of all advertising spaces per audience category during day 1; determine a global price per audience category for any advertising space during day 1 by dividing said total revenues of all advertising spaces per audience category by said global audience rating of all advertising spaces per audience category; determine the theoretical revenues of each of said advertising spaces per audience category during day 2 by multiplying said global price per audience category by the audience of each of said advertising spaces for the corresponding category during day 1; determine average theoretical revenues of each of said advertising spaces for all audience categories groups during day 2; determine the fair market value of each of said advertising spaces during said second time period by multiplying said average theoretical revenues of each of said advertising spaces by a global audience rating of the corresponding advertising space during day 1.

tracking means 6 for collecting audience statistics of each advertising space 51, 52, 53.

third means for inputting and storing, in a fourth database 15, selected target format specified by advertisers when buying said advertising space by selecting a target format category and corresponding to the advertising revenues of each of said advertising spaces during said first time period,

Said computer processor means 12 are programmed to process data stored in said fourth database 15, in order to: distribute said advertising revenues generated by each of said advertising spaces among advertising space formats in order to obtain total revenues per advertising space format; calculate average revenues per advertising space per format by dividing said total revenues per advertising space format by the number of advertising spaces of the corresponding format; calculate average revenues per advertising space by dividing total revenues of all advertising spaces by the total number of advertising spaces; calculate a format correction coefficient for each advertising space format by dividing said average revenues per advertising space per format by said average revenues per advertising space; calculate a corrected fair market value of each of said advertising spaces during said second time period by multiplying said fair market value by the corresponding format correction coefficient.

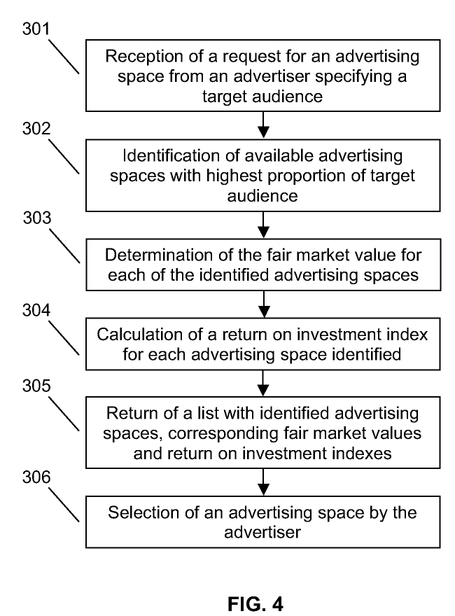

The present invention further regards a method for selling multimedia advertising spaces. According to this method, schematically presented on FIG. 4, in a first step (block 301), the advertiser connects onto an online interface and places an order for an advertising space. The request 31 from the advertiser specifies a target audience and an advertising space format.

The target audience is for example specified by selecting target audience categories on an online form. This request 31 can also specify different constraints regarding the advertising space requested, such as: the format of the advertising space, for example, selected in a list of available formats such as horizontal or vertical banners or video squares, the time frame for displaying the advertisement.

The advertiser can request the advertisement to be displayed right after the order has been confirmed for example on day 2, depending on availability of the advertising space or on any other period, for instance on day 180.

An order processed on a given time period, in this case day 2, is always valued based on fair market values and format correction coefficients calculated on a previous time period, in this case day 1. It does not matter whether the advertisement is to be displayed on the next time period, in this case day 3 or on a further time period, for example 6 months later.

In a second step represented in block 302, a list of advertising spaces with highest target audience proportion is identified. Audience statistics of all available advertising spaces are processed by the computer processor 12 accessing said first database 11 to compare the audience per advertising space per sub-category.

In a third step, represented in block 305, the fair market value of said identified advertising spaces is calculated as described earlier by said method for determining fair market values of advertising spaces.

In order to help advertisers in their decision, a return on investment index corresponding to each advertising space of said list is calculated (block 304) by dividing the target audience rating by the audience rating of said advertising space to obtain a target audience percentage, and dividing this target audience percentage by the calculated fair market value of said advertising space. This return on investment index is returned with said list of identified advertising spaces to the advertiser. The list is then displayed with corresponding fair market values and return on investment index.

If the final fair market value is calculated, the return on investment index is calculated by multiplying the target audience rating by the adjusted click-through ratio and dividing the result by the calculated fair market value of said advertising space.

Advertisers want to minimize the price to be paid and maximize the probability to display their advertisements to the target audience. As a result they usually want to maximize the return on investment index. Said list of identified advertising spaces is therfore classified according to the return on investment index.

However advertisers are not obliged to select the advertising space with maximum return on investment index. They can choose another advertising space, for example if they think a web page does not match the brand values of the product they want to advertise.

In a following step represented in block 305, said list of identified advertising spaces is returned to the advertiser along with their corresponding fair market values and return on investment indexes. This list is displayed to the advertiser with means for selecting an advertising space.

In a following step represented in block 306, an advertising spaces selection from said list is received from the advertiser.

Once the advertiser has made his choice by selecting an advertising space of the list, the transaction can be completed.

Although this method is described here for an example where the advertiser buys a single advertising space, it can of course be applied in the same way when the advertiser wishes to buy several advertising spaces.

Alternatively, the step of calculating a return on investment index can be skipped.

In another embodiment of the invention, only the advertising space with highest return on investment index is returned to the advertiser.

The method of selling multimedia advertising spaces further comprises a step of receiving the advertiser's payment.

Payment can be processed in different ways. If the order specifies a given number of thousand impressions, the final price is simply determined by multiplying the advertising space fair market value by the number of thousand impressions requested for the advertisement.

If the order specifies a time frame for displaying the advertisement different payment methods are possible, for example, “upfront”, “after” or “hybrid” payment.

“Upfront” payment is chosen if the advertiser pays the advertising space before the advertisement is actually displayed. The order price is therefore determined by multiplying the advertising space fair market value by a predicted number of thousand impressions obtained from a moving average on a given number of time periods.

“After” payment is chosen if the advertiser pays the order after the advertisement has been displayed on the selected advertising space. The order price is therefore determined by multiplying the advertising space fair market value determined on the day of the transaction by the actual number of thousand impressions of the advertisement.

“Hybrid” payment is chosen if the advertiser pays an advance to the publisher before the advertisement is actually displayed. The advance is calculated by multiplying the advertising space fair market value by a predicted number of thousand impressions obtained from a moving average on a given number of time periods. The final order price is calculated based on the actual number of thousand impressions of the advertisement and compared to the advance. If the advance is higher than the actual price, the publisher pays back the difference (or grants a credit note) to the advertiser. If the advance is lower than the actual price, the advertiser pays the difference to the publisher.

After payment of the transaction, the advertisement is stored in said fourth database until the time-period during which it was ordered to be displayed, and is then displayed automatically.

Alternatively, advertisers can choose advertising spaces that are not in said returned list.

They can also choose to negotiate with the publisher. In that case, the method of selling multimedia advertising spaces further comprises steps of:

receiving a price request for said advertising spaces selection from the advertiser,

transmitting said price request to said advertising spaces selection's publisher.

For example, an advertiser highly interested in a specific advertising space can bid more than the calculated fair market value. Alternatively if he thinks that an advertising space is too expensive, he can bid less.

A publisher can think that the calculated fair market value under-valuates the price of his advertising spaces and consequently asks a higher price to advertisers interested in his spaces. Alternatively the publisher might want to boost his sales and asks advertisers to pay a lower price than the calculated fair market value.

The price decided by the publisher is then subsituted to the calculated fair market value in the list returned to the advertiser.

When said advertising spaces publisher's approval is received, the transaction can be completed as described before.

In another alternative embodiment of the method of selling multimedia advertising spaces, only the advertising spaces with highest return on investment index are returned to the advertiser. The advertiser then only has to approve this advertising spaces selection to complete the transaction.

This method can be implemented by an internet system 2 as represented on FIG. 1, for selling multimedia advertising spaces, comprising a database operable for maintaining audience statistics data, advertising spaces data such as format, topic and revenues, advertisers data such as target audience selected, advertisement data; and a web server.

Said database comprises here first, second, third, fourth and fifth databases 11, 13, 14, 15, 17 described earlier.

This web server is operable to receive from an advertiser a request for an advertisement to be exposed to a target audience through for example an online interface allowing advertisers to send a request for an advertisement and selecting means allowing the advertisers to select the target audience of said advertisement by specifying a target audience sub-category.

It is operable to identify a list of advertising spaces with highest target audience proportion, for example by accessing and processing data from audience statistics stored in said database, and to calculate the fair market value of said identified advertising spaces according to the method for determining a fair market value described earlier, for example thanks to a computer system as described earlier.

The web server is also operable to calculate said return on investment index. It can either return said list of advertising spaces with highest target audience proportion with or without their return on investment index, or identify the advertising space of said list with highest return on investment index and return this single advertising space for approval.

Displaying means allow to display the returned list of the identified advertising spaces along with their fair market values, to the advertiser and selecting means are provided to the advertiser to select the advertising spaces he wishes to advertise on from said returned list.

The web server receives the advertiser's payment, stores said advertisement in said database and automatically displays said advertisement in said advertising space.

Although the present invention has been described in detail with respect to certain embodiments and examples, variations and modifications exist which are within the scope of the present invention as defined in the following claims.

The selling system can for example submit the advertisement to the concerned publisher for approval.

Although average theoretical revenues for each of said advertising spaces during said first time period are determined for all audience categories groups in the present description, these average theoretical values could be determined for any given set of audience categories groups,

In an alternative method for selling multimedia advertising spaces, the advertiser could specify a daily budget for his advertising campaign. This budget would be distributed among available advertising spaces with highest return on investment index and an advertising campaign proposal would be returned to the advertiser. The advertiser could then approve the proposed campaign or deselect undesirable advertising spaces, so that the corresponding budget could be redistributed to the available advertising spaces with the next highest return on investment index.

Advertising spaces could be grouped according to their format or to their audience and/or reputation. For instance websites with audience over 1,000,000 impressions/day and websites with audience below 1,000,000 impressions/day would belong to different markets and would therefore be valuated separately. These different advertising spaces groups would be separately priced according to the method described here.

1. Method for determining fair market values of multimedia advertising spaces during a second time period, these multimedia advertising spaces having been bought during a first time period anterior to the second one by advertisers, comprising the steps of:
a) collecting and storing, in a first database, audience statistics of each of said advertising spaces during said first time period, these audience statistics allowing to quantify the audience of each of said advertising spaces according to a given number of audience categories, wherein said audience categories are grouped into audience categories groups, each of these audience categories groups describing the whole audience,
b) collecting and storing, in a second database, advertising revenues of each of said advertising spaces during said first time period,
c) said advertisers having specified a target audience by selecting target audience categories when buying said advertising spaces, collecting and storing, in a third database, selected target audience categories corresponding to the advertising revenues of each of said advertising spaces during said first time period,
d) based on data obtained in step a) and on data obtained in step b) and/or in step c), distributing said advertising revenues of each of said advertising spaces among said audience categories and summing these revenues per advertising space per audience category for all advertising spaces in order to determine the total revenues of all advertising spaces per audience category during said first time period,
e) based on data obtained in step a), determining a global audience rating of all advertising spaces per audience category during said first time period,
f) based on results of steps d) and e), determining a global price per audience category for any advertising space during said first time period by dividing said total revenues of all advertising spaces per audience category by said global audience rating of all advertising spaces per audience category,
g) based on the result obtained in step f) and on data obtained in step a), determining theoretical revenues for each of said advertising spaces per audience category during said first time period by multiplying said global price per audience category by a corresponding audience rating per advertising space per audience category during said first time period,
h) based on the result obtained at step g), determining average theoretical revenues for each of said advertising spaces for at least a set of audience categories groups during said first time period,
i) based on the result obtained at step h) and on the data obtained in step a), determining a fair market value of each of said advertising spaces during said second time period by dividing said average theoretical revenues of each of said advertising spaces by an audience rating of the corresponding advertising space during said first time period.

2. Method for determining fair market values of multimedia advertising spaces according to claim 1, wherein said multimedia advertising spaces are, but not limited to, the following: online spaces of internet web pages, broadcast spaces on television, cinema or radio, outdoor spaces or spaces in a printed media.

3. Method for determining fair market values of multimedia advertising spaces according to claim 1, wherein said audience categories groups comprise at least one of the following: gender, age, income, education, language, hobbies, interests, searched keywords and web pages visited.

4. Method for determining fair market values of multimedia advertising spaces according to claim 1, wherein in step h), said average theoretical revenues of each of said advertising spaces for at least a set of audience categories groups are calculated by
summing said theoretical revenues of each of said advertising spaces per audience category for said set of audience categories of each group in order to obtain theoretical revenues of each of said advertising spaces per audience group during said second time period, and
averaging said theoretical revenues of each of said advertising spaces per audience group for said set of audience groups.

5. Method for determining fair market values of multimedia advertising spaces according to claim 1, wherein in step h), said average theoretical revenues of each of said advertising spaces for all audience are calculated by
summing said theoretical revenues of each of said advertising spaces per audience category for at least a set of audience categories of each group in order to obtain theoretical revenues of each of said advertising spaces per audience group during said first time period, and
multiplying said theoretical revenues of each of said advertising spaces per audience group by a weighting coefficient, the sum of the weighting coefficients for all audience groups considered being 1.

6. Method for determining fair market values of multimedia advertising spaces according to claim 5, wherein said weighting coefficient is calculated for each audience categories group through the following steps:
distributing said advertising revenues of each of said advertising spaces only among target audience groups specified by the advertiser and summing these revenues per advertising space per audience categories group for all advertising spaces in order to determine the total revenues of all advertising spaces per audience categories group during said first time period, and
summing said total revenues of all advertising spaces per audience group for all groups in order to determine total revenues of all advertising spaces, and
dividing said total revenues of all advertising spaces per audience group by said total revenues of all advertising spaces and multiplying by 100.

7. Method for determining fair market values of multimedia advertising spaces according to claim 1, wherein in step e), said global audience rating of all advertising spaces per audience category during said first time period is calculated by summing said audience of each of said advertising spaces per audience category collected in step a) for all advertising spaces.

8. Method for determining fair market values of multimedia advertising spaces according to claim 1, wherein in step i), said audience rating of each of the advertising spaces during said first time period is calculated by summing said audience of each of said advertising spaces per audience category collected in step a) for all categories of a given audience categories group.

9. Method for determining fair market values of multimedia advertising spaces according to claim 1, wherein said advertising spaces exhibit different format, said method comprising the following steps:
j) said advertisers having specified a target format by selecting a target format category when buying said advertising spaces, collecting and storing, in a fourth database, selected target format corresponding to the advertising revenues of each of said advertising spaces during said first time period,
k) distributing said advertising revenues generated by each of said advertising spaces among advertising space formats in order to obtain total revenues per advertising space format,
l) calculating average revenues per advertising space per format by dividing said total revenues per advertising space format by the number of advertising spaces of the corresponding format,
m) calculating average revenues per advertising space by dividing total revenues of all advertising spaces by the total number of advertising spaces,
n) calculating a format correction coefficient for each advertising space format by dividing said average revenues per advertising space per format by said average revenues per advertising space,
p) calculating a corrected fair market value of each of said advertising spaces during said second time period by multiplying said fair market value determined in step h) by the corresponding format correction coefficient.

10. Method for determining fair market values of multimedia advertising spaces according to claim 1, wherein any combination of two or more audience categories, each of them belonging to a distinct audience categories group, defines an audience sub-category.

11. Method for determining fair market values of multimedia advertising spaces according to claim 9, wherein total revenues of all advertising spaces per audience sub-category and global audience rating of all advertising spaces per audience sub-category are determined and a global price per audience sub-category is calculated by their ratio.

12. A computer system for determining fair market values of multimedia advertising spaces during a second time period, these multimedia advertising spaces having been bought during a first time period anterior to the second one by advertisers, comprising:
tracking means collecting each advertising space revenues and corresponding target audience, said advertisers having specified a target audience by selecting target audience categories when buying said advertising spaces,
first means for inputting and storing in a first database audience statistics of each of said advertising spaces during said first time period, these audience statistics allowing to quantify the audience of each of said advertising spaces according to a given number of audience categories, wherein said audience categories are grouped into audience categories groups, each of these audience categories groups describing the whole audience,
second means for inputting and storing advertising revenues generated by each of said advertising spaces during said first time period and corresponding selected target audience categories in a second and a third databases,
computer processor means for processing data stored in said first and second and/or third databases, programmed to: distribute said advertising revenues of each of said advertising spaces among said audience categories and summing these revenues per advertising space per audience category for all advertising spaces in order to determine the total revenues of all advertising spaces per audience category during said first time period; determine the global audience rating of all advertising spaces per audience category during said first time period; determine a global price per audience category for any advertising space during said first time period by dividing said total revenues of all advertising spaces per audience category by said global audience rating of all advertising spaces per audience category; determine the theoretical revenues of each of said advertising spaces per audience category during said second time period by multiplying said global price per audience category by the audience of each of said advertising spaces for the corresponding category during said first time period; determine average theoretical revenues of each of said advertising spaces for at least a set of audience categories groups during said second time period; determine the fair market value of each of said advertising spaces during said second time period by multiplying said average theoretical revenues of each of said advertising spaces by an audience rating of the corresponding advertising space during said first time period.

13. A computer system for determining fair market values of multimedia advertising spaces according to claim 12, further comprising:
tracking means collecting audience statistics of each advertising space.

14. A computer system for evaluating a fair market value of multimedia advertising spaces according to claim 12, further comprising:
third means for inputting and storing, in a fourth database, selected target format specified by advertisers when buying said advertising space by selecting a target format category and corresponding to the advertising revenues of each of said advertising spaces during said first time period,
said computer processor means being programmed to process data stored in said fourth database, in order to: distribute said advertising revenues generated by each of said advertising spaces among advertising space formats in order to obtain total revenues per advertising space format; calculate average revenues per advertising space per format by dividing said total revenues per advertising space format by the number of advertising spaces of the corresponding format; calculate average revenues per advertising space by dividing total revenues of all advertising spaces by the total number of advertising spaces; calculate a format correction coefficient for each advertising space format by dividing said average revenues per advertising space per format by said average revenues per advertising space; calculate a corrected fair market value of each of said advertising spaces during said second time period by multiplying said fair market value by the corresponding format correction coefficient.

15. Method for selling multimedia advertising spaces, comprising the following steps:
receiving from an advertiser a request for an advertisement to be exposed to a target audience,
identifying a list of advertising spaces with highest target audience proportion,
calculating the fair market value of said identified advertising spaces as claimed in claim 1,
calculating a return on investment index, by dividing the target audience by the global audience of said identified advertising spaces to obtain a target audience percentage, and dividing this target audience percentage by the calculated fair market value of said identified advertising spaces,
selecting the advertising space of said list with highest return on investment index,
returning the fair market value of the selected advertising spaces to the advertiser,
receiving advertiser's payment,
storing said advertisement in a fifth database,
automatically displaying said advertisement in said advertising spaces.

16. Internet system for selling multimedia advertising spaces, comprising:
a database operable for maintaining audience statistics data, advertising spaces data such as format, topic and revenues, advertisers data such as target audience selected, advertisement data,
a web server operable to:
receive from an advertiser a request for an advertisement to be exposed to a target audience,
identify a list of advertising spaces with highest target audience proportion,
calculate the fair market value of said identified advertising spaces as claimed in claim 1,
calculate a return on investment index, by dividing the target audience by the audience rating of said identified advertising spaces to obtain a target audience percentage, and dividing this target audience percentage by the calculated fair market value of said identified advertising spaces,
select the advertising spaces of said list with highest return on investment index,
return the fair market value of the selected advertising space to the advertiser
receive advertiser's payment,
store said advertisement in said database,
automatically display said advertisement in said advertising spaces.

17. Internet system for selling multimedia advertising spaces, comprising:
a database operable for maintaining audience statistics data, advertising spaces data such as format, topic and revenues, advertisers data such as target audience selected, advertisement data,
a web server operable to:
receive from an advertiser a request for an advertisement to be exposed to a target audience,
identify a list of advertising spaces with highest target audience proportion,
calculate the fair market value of said identified advertising spaces as claimed in claim 9,
calculate a return on investment index, by dividing the target audience by the audience rating of said identified advertising spaces to obtain a target audience percentage, and dividing this target audience percentage by the calculated fair market value of said identified advertising spaces,
select the advertising spaces of said list with highest return on investment index,
return the fair market value of the selected advertising space to the advertiser
receive advertiser's payment,
store said advertisement in said database,
automatically display said advertisement in said advertising spaces.

18. Method for selling multimedia advertising spaces, comprising the following steps:
receiving from an advertiser a request for an advertisement to be exposed to a target audience,
identifying a list of advertising spaces with highest target audience proportion,
calculating the fair market value of said identified advertising spaces as claimed in claim 9,
calculating a return on investment index, by dividing the target audience by the global audience of said identified advertising spaces to obtain a target audience percentage, and dividing this target audience percentage by the calculated fair market value of said identified advertising spaces,
selecting the advertising space of said list with highest return on investment index,
returning the fair market value of the selected advertising spaces to the advertiser,
receiving advertiser's payment,
storing said advertisement in a fifth database,
automatically displaying said advertisement in said advertising spaces.
